(19) United States
(12) Patent Application Publication
(10) Pub. No.: US 2013/0119316 A1
(43) Pub. Date: May 16, 2013

(54) Boron nitride and boron nitride nanotube materials for radiation shielding

(71) Applicants: Godfrey Sauti, Hampton, VA (US); Cheol Park, Yorktown, VA (US); Jin Ho Kang, Newport News, VA (US); Jae-Woo Kim, Newport News, VA (US); Joycelyn S. Harrison, Arlington, VA (US); Michael W. Smith, Newport News, VA (US); Kevin Jordan, Newport News, VA (US); Sharon E. Lowther, Hampton, VA (US); Peter T. Lillehei, Yorktown, VA (US); Sheila A. Thibeault, Hampton, VA (US)

(72) Inventors: Godfrey Sauti, Hampton, VA (US); Cheol Park, Yorktown, VA (US); Jin Ho Kang, Newport News, VA (US); Jae-Woo Kim, Newport News, VA (US); Joycelyn S. Harrison, Arlington, VA (US); Michael W. Smith, Newport News, VA (US); Kevin Jordan, Newport News, VA (US); Sharon E. Lowther, Hampton, VA (US); Peter T. Lillehei, Yorktown, VA (US); Sheila A. Thibeault, Hampton, VA (US)

(73) Assignees: National Institute of Aerospace Associates, Hampton, VA (US); Thomas Jefferson National Accelerator Facility, Newport News, VA (US); and Space Administration, Washington, DC (US); United States of America as represented by the Administrator of the National Aeronauties

(21) Appl. No.: 13/068,329

(22) Filed: May 9, 2011

Related U.S. Application Data
(60) Provisional application No. 61/395,113, filed on May 7, 2010.

(51) Int. Cl. G21F 1/10

(52) U.S. Cl. CPC G21F 1/103
USPC 252/478

(57) ABSTRACT

Effective radiation shielding is required to protect crew and equipment in various fields including aerospace, defense, medicine and power generation. Light elements and in particular hydrogen are most effective at shielding against high-energy particles including galactic cosmic rays, solar energetic particles and fast neutrons. However, pure hydrogen is highly flammable, has a low neutron absorption cross-section, and cannot be made into structural components. Nanocomposites containing the light elements Boron, Nitrogen, Carbon and Hydrogen as well dispersed boron nano-particles, boron nitride nanotubes (BNNTs) and boron nitride nano-platelets, in a matrix, provide effective radiation shielding materials in various functional forms. Boron and nitrogen have large neutron absorption cross-sections and wide absorption spectra. The incorporation of boron and nitrogen containing nanomaterials into hydrogen containing matrices provides composites that can effectively shield against neutrons and a wide range of radiation species of all energies without fragmentation and the generation of harmful secondary particles.

### CROSS REFERENCE TO RELATED APPLICATION

This Application claims the benefit of U.S. Provisional Application No. 61/395,113, filed on May 7, 2010 for “Neutron and Ultraviolet Shielding Films Fabricated Using Boron Nitride Nanotubes and Boron Nitride Nanotube Polymer Composites.”

### STATEMENT REGARDING FEDERALLY SPONSORED RESEARCH OR DEVELOPMENT

The U.S. Government has a paid-up license in this invention and the right in limited circumstances to require the patent owner to license others on reasonable terms, as provided for by the terms of Contract No. NCC-1-02043 awarded by the National Aeronautics and Space Administration.

### BACKGROUND OF THE INVENTION

1. Field of the Invention

The present invention relates to radiation shielding material, and, more particularly to radiation shielding material fabricated with boron containing materials.

2. Description of Related Art

Radiation, in particular, neutrons, galactic cosmic rays (GCRs) and energetic protons (such as those from the sun), continue to pose a hazard to crew, passengers and equipment in the aerospace and other industries. For example, research results indicate that for flights within the commercial height range, aircrew and frequent flying passengers may be subject to radiation dose levels significantly above those permitted for members of the ‘public’ under statutory recommendations [B. Mukherjee and P. Cross; “Analysis of neutron and gamma ray doses accumulated during commercial Trans-Pacific flights between Australia and USA”, Radiation Measurements 32 (2000) 43-48]. One hazard of neutron radiation is neutron activation which is the ability of neutron radiation to induce radioactivity in most substances it encounters, including the body tissues of the workers themselves. Equipment and crews on spacecraft that, for part or all of their flight profiles, have to enter into low earth orbit or above are subjected to even higher radiation risks. The risk posed by radiation has long been recognized as one of the major challenges to frequent and long duration spaceflight. The current duration of space missions is limited by among other things, the exposure of crews and equipment to highly energetic GCRs as well as protons and other high energy particles from the sun. In the atmosphere, the interaction of cosmic rays with oxygen and nitrogen creates secondary particles including high energy neutrons, protons, pions, mesons, electrons, photons and nuclear fragments. The peak flux of the radiation occurs at ˜60,000 ft and then slowly drops off to sea level. At normal aircraft cruising altitudes the radiation is several hundred times the ground level intensity and at 60,000 ft, a factor of three higher again. In aircraft, the high energy atmospheric neutrons are moderated, or slowed, by the hydrogenous materials producing a high thermal neutron flux. These materials include mainly polymeric materials, as well as fuel, baggage, and people. As microchip size and operating voltages go down, thermal neutrons are an increasingly important cause of Single Event Effects (SEE) in avionics electronics systems [IEC TECHNICAL SPECIFICATION TS 62396-1 “Process management for avionics—Atmospheric radiation effects “]. The radiation would similarly affect passenger electronics devices.

Materials for radiation shielding have been studied extensively with various formulations of hydrogen, boron and lithium containing materials being used for neutron shielding. Water, polyethylene, paraffin wax, or concrete, where considerable amounts of water molecules are chemically bound to the cement, have been used for neutron attenuation. Lead has also been used for shielding various types of radiation principally, alpha particles, gamma rays and x-rays.

Several factors affect the suitable materials for radiation shielding in aerospace applications:
1. Their constituent elements must have low atomic masses to prevent fragmentation from collisions with high-energy particles.
2. They must be light weight (A problem for higher atomic weight materials).
3. They must have a small volume in order to fit into the launch payload fairing. (A problem for the hydrogen filled materials such as water (H₂O) and low density polyethylene (LDPE)).
4. They should be mechanically strong and tough as well as stable at elevated temperatures.
5. They should have low flammability (a disadvantage of some high hydrogen containing materials).
6. It is often desirable that upon the addition of a radiation shielding filler, the material retains properties such as optical transparency and mechanical robustness.

Aerospace durable polymers (e.g. polyimides) have already been developed for next generation aerospace vehicles to reduce the weight. BNNTs possess all the suitable characteristics described above as radiation shielding materials in aerospace applications as seen in Table 1.

TABLE 1
The physical characteristics of boron nitride nanotubes.

| Characteristics | Boron nitride nanotubes |
|---|---|
| Electrical properties | Always semiconducting |
| | (about 5.5 eV band gap) |
| Mechanical properties | 1.18 TPa |
| (Young's modulus) | |
| Thermal conductivity | ~3000 W/mK |
| Thermal oxidation resistance | Stable up to 800° C. in air |
| Neutron absorption cross- | B = 767 (B¹⁰ ~3800) |
| section | N = 1.9 |
| | The high cross-section, in |
| | addition to the low atomic masses |
| | of both boron and nitrogen, result |
| | in excellent radiation shielding, |
| | covering a range of particle species |
| | and energies. |
| Polarity | Permanent dipole |
| | Piezoelectric (0.25-0.4 C/m²) |
| Surface morphology | Corrugated |
| Color | White |
| Coefficient of Thermal | −1 × 10⁻⁶ |
| Expansion | |

The addition of BNNTs into the matrix leads to a composite that can provide structural as well as radiation shielding properties with minimal weight penalty. A comparison of the materials used in aerospace structural applications shows the following neutron absorption cross sections (in barns) (Table 2).

TABLE 2
The physical properties, neutron scattering and absorption
cross-sections for 2200 m/s neutrons of various materials.
(http://www.ncnr.nist.gov/resources/n-lengths/).

| | | | | Neutron |
|---|---|---|---|---|
| | | | | Absorption |
| | Atomic | | Neutron Scatter | Cross-sections |
| Material | mass | Density (g/cm³) | Cross Sections | (barns) |
| Hydrogen | 1.01 | gas | 82.02 | 0.33 |
| Boron | 10.81 | Boron nitride | 5.24 | 710 |
| | | (“BN”) (2.27); | | (¹⁰B: 3835) |
| | | BNNT (1.37) | | |
| Carbon | 12.01 | 1.8-3.5 | 5.55 | 0.0035 |
| Nitrogen | 14.01 | gas | 11.51 | 1.9 |
| Oxygen | 16.00 | gas | 4.23 | 0.00019 |
| Aluminum | 26.98 | 2.7 | 1.50 | 0.231 |
| Titanium | 47.87 | 4.54 | 4.35 | 5.0 |
| Lead | 207.2 | 11.34 | 11.12 | 0.17 |

Hydrogen containing materials have been widely investigated for use as a radiation shielding material. Hall et al. [“Non-Combustible Nuclear Radiation Shields with High Hydrogen Content,” U.S. Pat. No. 4,123,392 (1978)] describe non-combustible nuclear radiation shields with high hydrogen content. They suggest dispersing hydrogen containing material in a fire resistant matrix. Ohuchi et al. [“Neutron-Shielding Fabric And Composite Fiber and Method of Manufacture Thereof,” U.S. Pat. No. 4,522,868 (1985)] describe a neutron-shielding material consisting of a fiber-forming polymer as the core-component containing neutron-shielding materials with a sheath component made of a fiber-forming polymer that is capable of bonding to the core-component. Hamby et al. [“Composite Thermal Insulation and Radioactive Radiation Shielding,” U.S. Pat. No. 5,814,824 (1998)] describe a composite thermal insulation and radioactive radiation shielding device consisting of multiple layers; at least one inner layer, at least one outer layer and a shielding layer that reduces the radioactive radiation. Cummins [“Radiation Shielding for Space Craft Components,” U.S. Pat. No. 5,324,952, (1994] describes an apparatus consisting of a first layer to provide primary radiation attenuation and a second layer to provide primary and secondary radiation attenuation. Composites containing micrometer scale boron nitride powders have been suggested for neutron shielding [Harrison et al., “Polyethylene/Boron Nitride Composites for Space Radiation Shielding”, Journal of Applied Polymer Science, 109, 2529 (2008)]. Lead has also been used for shielding various types of radiation, principally alpha particles, gamma rays and x-rays.

There are a number of disadvantages to the related art, in particular the inability to achieve very high effective cross sections of the shielding material. This necessitates the use of relatively large amounts of the filler material in order to be able to achieve effective shielding. The reliance on high hydrogen content brings with it problems including low material density (high volume required for effective shielding) and flammability for some polymers. The use of micron size powders, as is currently described in the literature, leads to high filler volume fraction thresholds for effective radiation attenuation. This brings with it the problems of increased weight (the fillers are generally more dense than the matrix), increased cost, as larger amounts of neutron attenuating filler are required, very poor processibility as the filler volume increases and a drastic decrease in the other desirable properties of the resultant materials. Lead shields are extremely heavy because of lead's high density and they are not effective at shielding against neutrons. Furthermore high energy electrons (including beta radiation) incident on lead may create bremsstrahlung radiation, which is potentially more dangerous to tissue than the original radiation. Lead is also extremely toxic to human health, leading to handling difficulties.

A large neutron absorption cross section, low atomic masses of the constituent elements, along with light weight and the large surface area of BNNTs enable them to shield a target material very effectively with much less volume and weight compared to hydrogen, lead, or macroscopic BN particle containing materials.

Additional thermal stability and mechanical robustness can make the radiation shielding BNNT materials more valuable for many applications in harsh environments such as high-altitude aerospace flights, space exploration and military applications (armor) as well as conventional radiation shielding for conventional applications (automobile, solar energy housing and buildings, cosmetics, clothing, blankets, helmets and so on.)

In addition, BNNT materials can shield ultraviolet (UV) radiation very effectively as well since BNNT can absorb and scatter UV range light very efficiently.

Any nano-sized inclusions (including 0D (nano-particle), 1D (nanotube), and 2D (nano-platelet)) containing boron 10 would be good candidates for effective radiation shielding materials including but not limited to boron nitride nanotubes (BNNT), boron carbon nitride (BCN) nanotubes), boron doped carbon nanotubes, boron nitride nano-plateletes (nanometer-thick h-BN sheets).

It is a primary aim of the present invention to provide radiation shielding material fabricated with boron nitride nanotubes (BNNTs) and nanoscale boron nitride materials. Much thinner layers or coatings of BNNT and/or BN containing materials are required to shield a subject of interest compared to other shielding materials.

It is an object of the invention to enhance radiation shielding by the controlled addition and dispersion of BN and BNNT containing materials into a matrix (polymer or ceramic). Nanoscale BNs and BNNTs are very effective to disperse boron and nitrogen atoms homogeneously throughout the shielding materials when compared to macroscopic bulk materials.

It is an object of the invention to achieve effective radiation shielding by homogeneously dispersing a boron containing material (i.e., boron atoms, boron nano-particles (0D), boron nitride nanotubes (BNNTs) (1D), boron nitride nano-platelets (2D), or the polymer composites thereof) into a matrix synthesized from a hydrogen containing polymer, a hydrogen containing monomer, or a combination thereof

It is an object of the invention to achieve effective radiation shielding by homogeneously dispersing a boron containing material (i.e., boron atoms, boron nano-particles (0D), boron nitride nanotubes (BNNTs) (1D), boron nitride nano-platelets (2D), or the polymer composites thereof) into a matrix synthesized from a boron containing polymer, a boron containing monomer, or a combination thereof

It is an object of the invention to achieve effective radiation shielding by homogeneously dispersing a boron containing material a boron containing material (i.e., boron atoms, boron nano-particles (0D), boron nitride nanotubes (BNNTs) (1D), boron nitride nano-platelets (2D), or the polymer composites thereof) into a matrix synthesized from a nitrogen containing polymer, a nitrogen containing monomer, or a combination thereof.

It is an object of the invention to provide an optically transparent neutron and other radiation shielding material consisting of transparent polymer matrix and well dispersed boron nitride nanotubes. BNNTs are white and optically transparent in the visible light range.

It is a further object of the invention to produce optically transparent radiation shielding windows by the dispersion of boron nitride nanotubes into a polymer or ceramic matrix.

Finally, it is an object of the present invention to accomplish the foregoing objectives in a simple and cost effective manner.

The above and further objects, details and advantages of the invention will become apparent from the following detailed description, when read in conjunction with the accompanying drawings.

### SUMMARY OF THE INVENTION

The present invention addresses these needs by providing a method for manufacturing a material for providing shielding from radiation. A boron containing nanomaterial/polymer material is synthesized from a boron containing nanomaterial and a matrix by controlled dispersion of the boron containing nanomaterial into the matrix. The synthesized film is applied to an object to be protected from radiation. The boron containing nanomaterial is preferably boron atoms, boron nano-particles (0D), boron nitride nanotubes (BNNTs) (1D), boron nitride nano-platelets (2D), or polymer composites thereof. The boron containing nanomaterial is preferably homogeneously dispersed into the matrix. The boron containing nanomaterial/polymer material is preferably synthesized by in-situ polymerization under simultaneous shear and sonication. The matrix is preferably synthesized from a hydrogen, boron or nitrogen containing polymer; a hydrogen, boron or nitrogen containing monomer; or a combination thereof. The matrix is preferably synthesized from a diamine, 2,6-bis(3-aminophenoxy) benzonitrile ((β-CN)APB), and a dianhydride, pyromellitic dianhydride (PMDA). The concentration of boron nitride in the matrix is preferably between 0% and 5% by weight and specifically 5% by weight. The boron containing nanomaterial is preferably boron, nitrogen, carbon or hydrogen. The synthesized material is preferably in the form of a film, a fiber, a paste or a foam. A synthesized fiber is preferably incorporated into fabric. A synthesized paste is preferably applied to the surface of an object to provide protection from radiation or forms a layer within an object to provide protection from radiation. The matrix is preferably a polymer or ceramic matrix.

### BRIEF DESCRIPTION OF THE DRAWINGS

A more complete description of the subject matter of the present invention and the advantages thereof, can be achieved by reference to the following detailed description by which reference is made to the accompanying drawings in which:

FIG. 1 shows the effectiveness of neutron shielding using low loading BNNT/polyimide composites compared to that of the state of the art high filler volume fraction h-BN powder composites and LDPE;

FIG. 2 shows the optical properties of pristine polyimide and 5 wt % BNNT/polyimide composite as well as those of the 30 wt % h-BN powder and LDPE whose neutron shielding effectiveness is shown in FIG. 1.;

FIGS. 3A-3C show the forms in which the present invention can be realized include films, fibers and pastes/foams, each containing a polymer or ceramic matrix and boron containing nano-inclusions;

FIGS. 4A-4D shows the present invention can be used to produce clothing or clothing liners/undergarments (e.g. for astronaut and pilot suits), aprons, blankets, sleeping bags or liners thereof, for workers in high radiation environments including nuclear submariners and medical radiologists; and

FIG. 5 shows an implementation of the present invention can be used to form a layer for astronaut and pilot visors;

FIGS. 6A and 6B show use of the present invention in layers for aircraft windows and a lining for the passenger cabin. A boron nano-inclusion containing ‘paint’ is applied over the surface, which then cures to form a radiation shielding layer. Depending on the choice of polymer or ceramic matrix and structural requirements, the boron containing nanocomposite is utilized either as a coating on one side of a window base material, sandwiched between suitable window base materials or as a free standing window;

FIG. 7 shows boron containing nanocomposites can be used as ‘radiation-hardened’ packaging for electronic components; and

FIG. 8 shows boron containing nanocomposites can be used to make optically transparent windows/window coatings for vessels housing neutron generating reactions.

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention. The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

Effective shielding from radiation remains an important challenge in various fields including the defense and aerospace fields, medicine and nuclear power installations. Shielding is required in order to protect both crew and equipment. Hydrogen is the atom which has the lowest atomic mass and thus, materials with high hydrogen content have been most desirable for shielding energetic particles. However, hydrogen itself or hydrogen containing materials are required in large volumes in order to shield effectively. The nanocomposites described in this invention, would moderate (slow down) the energetic particles, including neutrons produced from collisions of high energy particles and capture the resultant thermal neutrons and other low energy species before they can interact with the electronics systems. By incorporating the nanocomposites into structural and interior fittings of the planes, such as the seating, flooring panels etc, the radiation shielding can be achieved at no additional weight penalty.

Generally, the present invention relates to the use of boron containing nanomaterials including boron nano-particles (0D), boron nitride nanotubes (BNNTs) (1D) and boron nitride nano-platelets (2D), as well as the polymer composites thereof, as a neutron shielding material. Boron, and in particular boron 10, has a large absorption cross-section for thermal neutrons (energy≈0.025 eV) and wide absorption spectrum. The incorporation of boron containing nanomaterials such as BNNTs into a hydrogen containing polymer, which is a good neutron moderator due to hydrogen's large neutron scattering cross-section, provides composites that very effectively shield against neutrons without cascading (or fragmentation) which is often observed with heavy elements.

Potential markets for BNNT based neutron and other ionizing radiation absorbers include in the aerospace industry where light weight materials with a high shielding effectiveness are required. With each kilogram launched to low earth orbit costing about ($10,000-$25,000), an effective, light-weight and low volume shield is desirable. Commercial aviation crews are also exposed to high radiation doses while in flight. The present invention provides a shielding material that is applied as a thin layer to cover aircraft cabins. The high optical transparency of the BNNT composites are used in manufacturing windows for use in high radiation environments. Additional thermal stability and mechanical robustness make the radiation shielding BNNT materials more valuable for many applications in harsh environments such as high-altitude aerospace flights, space exploration and military applications (armor) as well as conventional radiation shielding for conventional applications (automobile, solar energy housing and buildings, cosmetics, clothing, blankets, helmets and so on). BNNT nanocomposite materials are used to provide radiation shielding in the medical field and in nuclear power plants as well as for nuclear powered vessels, such as submarines, and future spacecraft. Linings consisting of the nanocomposite materials are also used as part of apparel worn by emergency first responders dealing with radioactive materials. Composites containing low atomic mass elements such as boron, nitrogen and hydrogen and carbon provide effective shielding from ionizing radiation including galactic cosmic rays and high energy protons from solar particle events encountered in space travel.

Since the first theoretical prediction of boron nitride nanotubes (BNNTs) in 1994 [A. Rubio et al, Phys. Rev. Lett. 49, 5081 (1994)] and the first experimentally synthesized BNNT report by Zettl's group in 1995 [N. G Chopra et al, Science, 269, 966 (1995)], several types of BNNT synthesis methods have been reported [D. Golberg et al, Adv. Mater., 19, 2413, (2007)]. Recently, a new and conceptually simple method of producing extraordinarily long, highly crystalline BNNTs was demonstrated. [M. W. Smith et al., U.S. patent application Ser. No. 12/152,414, filed May 14, 2008, entitled “Boron Nitride Nanotubes”, M. W. Smith et al, Nanotechnology, 20, 505604 (2009)], incorporated herein by reference in its entirety. BNNTs are thought to possess high strength-to-weight ratio, high temperature resistance (about 800° C. in air), piezoelectricity, and radiation shielding capabilities [D. Golberg ibid]. Boron nitride nanotubes have a low density (1.37 g/cm³) and boron has a large neutron absorption cross section 710 barns (¹⁰B: 3835 barns) (Table 2). Nitrogen also has fairly large neutron absorption cross-section of 1.9 compared to carbon of 0.0035, which is another benefit for effective shielding (Table 2). Because of their low atomic masses, the boron, nitrogen, carbon and hydrogen in BN and BNNT composites also act as effective shields for other radiation species. Further, the low atomic masses of boron, nitrogen and the hydrogen and carbon in BN/BNNT containing composites lead to effective shielding of high energy particles without fragmentation and creation of secondary particles. The current invention relates to the use of boron nitride nanotubes to form a nanoscale filler with large macroscopic cross section neutron absorption in a hydrogen containing space durable polymer or ceramic matrix.

First, BNNT/Polyimide nanocomposite films were synthesized by in-situ polymerization under simultaneous shear and sonication. A novel high temperature polyimide, synthesized from a diamine, 2,6-bis(3-aminophenoxy) benzonitrile (β-CN)APB), and a dianhydride, pyromellitic dianhydride (PMDA) and was used as a matrix for this invention. The concentrations of BNNTs in the polyimide were between 0 and 5 wt. %. A 30 wt. % micrometer scale hexagonal Boron Nitride (h-BN) particles and polyimide composite was made for comparison.

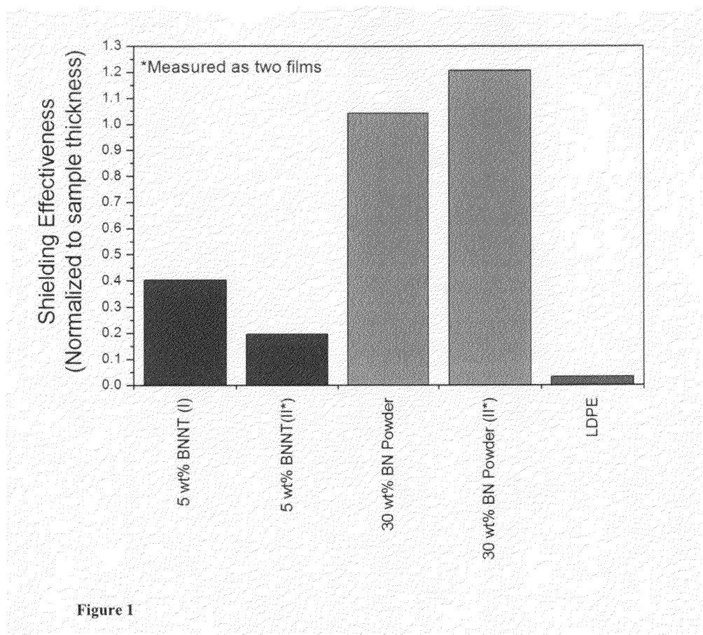

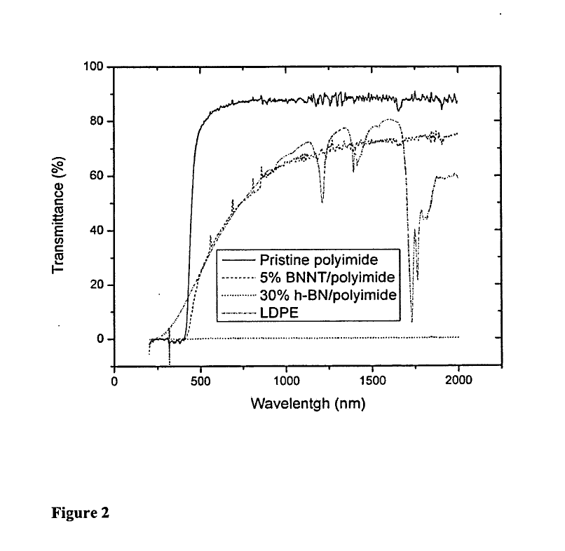

To ascertain the effectiveness of the BNNT/polyimide composite as a neutron absorber, a 1 Curie (Ci) Am/Be mixture was used as the neutron source and 1″ diameter indium foil was used as a detector. The results shown in FIG. 1 show the effectiveness of high BN powder loadings as well as that of much lower concentrations of BNNTs. Considering the low concentration of the unpurified BNNTs, the shielding effectiveness was the best among the tested samples, performing even better than high hydrogen containing LDPE (low density polyethylene) as well as the six times higher concentration of the BN powder. While the composite containing h-BN powder was opaque and highly brittle, the BNNT containing composite was transparent and flexible. While the average surface area of h-BN is about 3.6 m²/g, that of BNNT is greater than 500 m²/g, which is more than two orders of magnitude higher than h-BN. This large surface area BNNT enables it to shield a subject of interest very effectively with much lower loadings as compared to macroscopic h-BN particles. Pure BNNT materials can be also used as thin films or coatings to shield both crew and equipment very effectively with a smaller amount as compared to other shielding materials. FIG. 2 shows UV/Vis/NIR spectra of pristine and 5 wt. % BNNT/polyimide composite. The transmittance in Vis/NIR ranges decreased with adding BNNT, but still showed about 43% transparency at a 650 nm-wavelength. Below 400 nm wavelength, both samples were opaque which means that these are good for shielding UV radiation. Therefore BNNT can be used as UV shielding material as well.

The combination of a high microscopic absorption cross-section and the form factor of BNNTs lead to very high effective macroscopic absorption. Very low loadings of the BNNTs are able to reduce the neutron flux greatly while still giving a material that retains its other desirable properties.

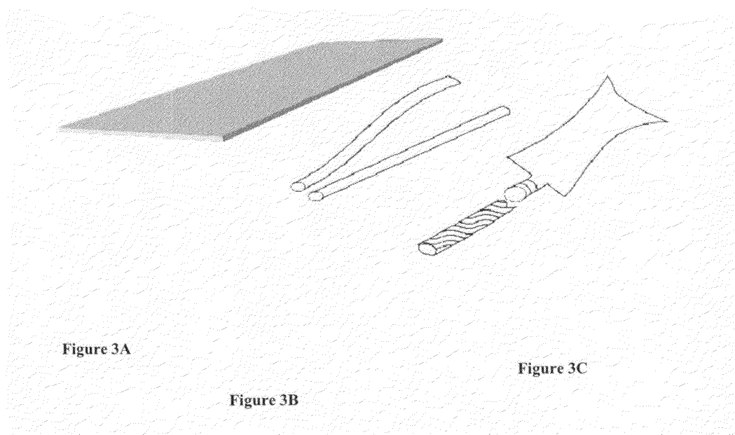

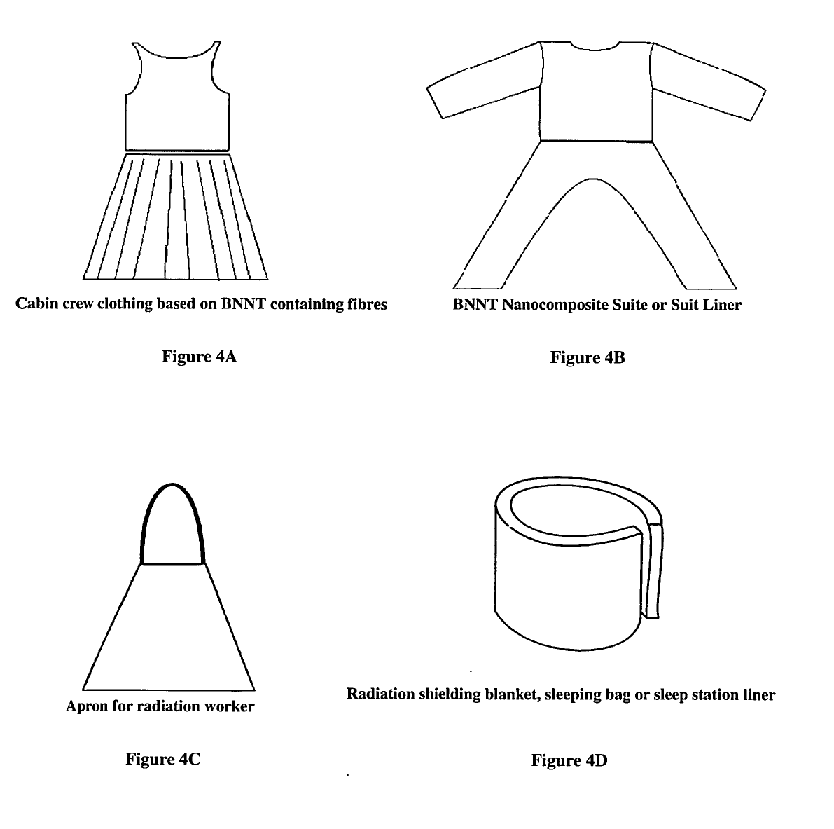

FIGS. 3A-3C show possible forms of the present invention while FIGS. 4 to 8 show possible areas of its use. Composites for radiation shielding using aligned or randomly dispersed BNNTs and/or other boron containing nano-inclusions are prepared in the form of films, fibers, pastes or foams (FIG. 3), by choosing a suitable polymer or ceramic matrix, the matrix choice being determined by the desired end application. Aerospace durable polymers (e.g. polyimides) have already been developed for next generation aerospace vehicles to reduce the weight; such polymers are chosen for aerospace environments to provide the necessary durability. For flexible radiation shielding materials, an elastomer can be used as a matrix. Where high optical transparency is required, polymers such as polycarbonate can be used. Among other applications, the present invention is utilized in the manufacture of clothing or clothing layers for use by workers in high radiation environments such as aircraft crew and astronauts. Boron nano-inclusion containing fibers are woven to form the appropriate garments or boron nano-inclusion containing films are used as a layer of such garments. One method for producing such fibers is shown in co-pending, published U.S. patent application Ser. No. 12/387,703, filed May 6, 2009 entitled, “Boron nitride nanotube fibrils and yarns,” incorporated by reference herein in its entirety. In nuclear medicine, boron nano-inclusion containing composites are used to protect patients and equipment operators from overexposure or unintended exposure. Neutrons are currently used or generated in various therapeutic radiological procedures where it is important that they not affect healthy cells. The nanocomposites also form a component of the apparel for the first responders to radioactive material spills or a ‘dirty’ nuclear bomb. In nuclear powered submarines, where sailors spend months at a time in a confined space, and future nuclear powered spacecraft and space vehicles, the boron nano-inclusion containing materials are used to protect the long term health of crews and instruments.

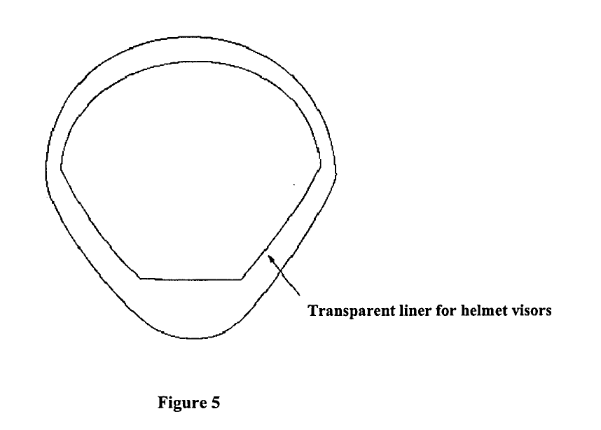

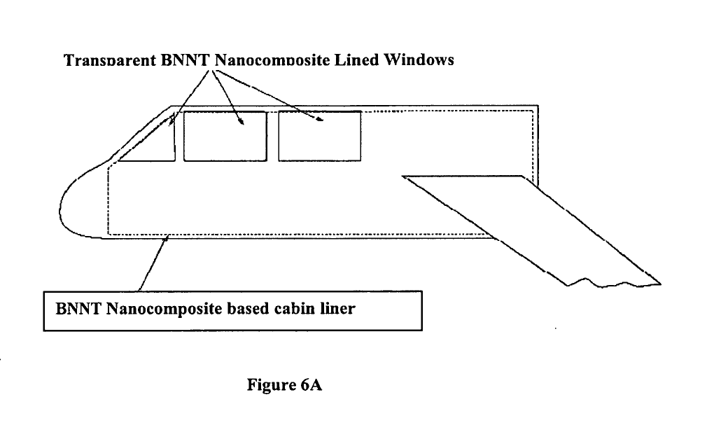

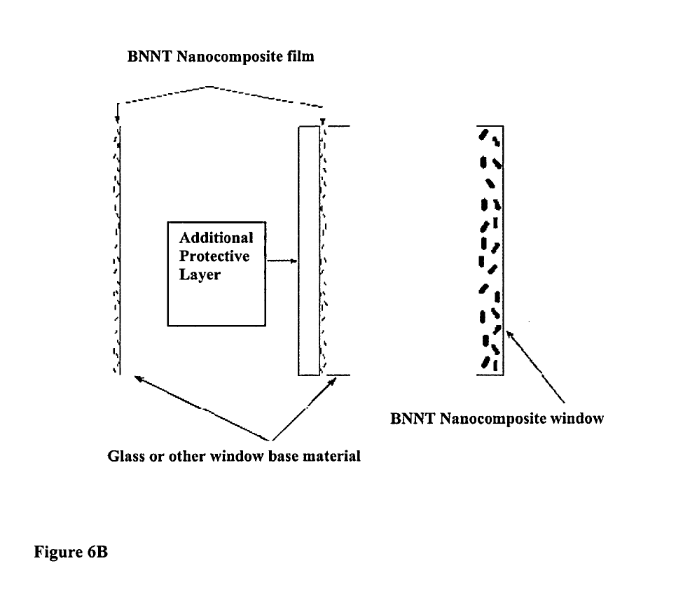

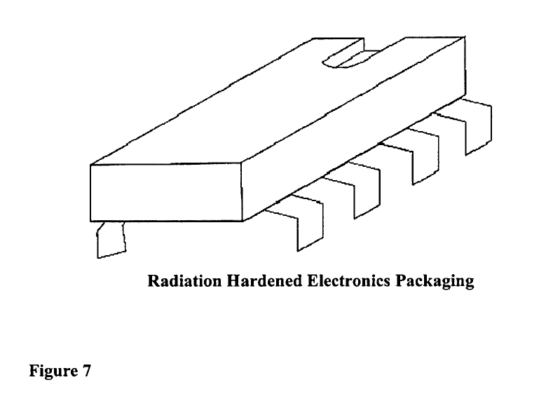

Because effective radiation shielding is achieved while maintaining optical transparency, the present invention is also used in the form of thin layers for helmet visors (FIG. 5), or aircraft windows (FIG. 6A). Woven fiber mats, large films or boron nano-inclusion containing ‘paints’ are used to form a lightweight covering to line entire cabin sections. The disclosed method, when formed into a paint-like paste or foam, is applied to the outer surface of an object to improve radiation protection. Boron nano-inclusion containing polymer composites are used to produce ‘radiation-hardened’ packaging for electronics components (FIG. 7), with such packaging some distance from the chip substrate to prevent secondary particles from interfering with the circuitry. Using BNNTs, which have a low electrical conductivity and a high thermal conductivity (see Table 1), is an additional advantage in this application as they enhance the packaging's capability to conduct heat out, while maintaining the electronics electrically isolated. Boron containing nanocomposites are also used as transparent windows of vessels for containing reactions generating thermal neutrons of appropriate energies (FIG. 8). Boron containing nanocomposites are used to protect crew and equipment from neutrons from the reactors in nuclear powered submarines and nuclear-powered spacecraft. Boron containing nanocomposites formed according to the present invention are used to protect instruments in craft powered by a radioisotope thermoelectric generator (RTGs). ²⁴²Cm and ²⁴¹Am, which are a potential fuel for RTGs, also require heavy shielding as they generate high neutron fluxes. Boron, nitrogen, hydrogen and carbon containing composites act to shield against positively charged particles of all energies—including protons, alpha particles, light ions, intermediate ions, heavy ions, galactic cosmic radiation particles, and solar energetic particles.

Obviously, many modifications may be made without departing from the basic spirit of the present invention. Accordingly, it will be appreciated by those skilled in the art that within the scope of the appended claims, the invention may be practiced other than has been specifically described herein. Many improvements, modifications, and additions will be apparent to the skilled artisan without departing from the spirit and scope of the present invention as described herein and defined in the following claims.

What is claimed is:

1. A method for manufacturing a material for providing shielding from radiation, comprising:
synthesizing a boron containing nanomaterial/polymer material from a boron containing nanomaterial and a matrix by controlled dispersion of the boron containing nanomaterial into the matrix; and
applying the synthesized material to an object to be protected from radiation.

2. The method of claim 1 wherein the boron containing nanomaterial is selected from the group consisting of boron atoms, boron nano-particles (0D), boron nitride nanotubes (BNNTs) (1D), boron nitride nano-platelets (2D), and the polymer composites thereof.

3. The method of claim 1 wherein the boron containing nanomaterial is homogeneously dispersed into the matrix.

4. The method of claim 1 wherein the boron containing nanomaterial/polymer material is synthesized by in-situ polymerization under simultaneous shear and sonication.

5. The method of claim 1 wherein the matrix is synthesized from a substance selected from the group consisting of a hydrogen containing polymer, a hydrogen containing monomer, and a combination thereof.

6. The method of claim 1 wherein the matrix is synthesized from a substance selected from the group consisting of a boron containing polymer, a boron containing monomer, and a combination thereof.

7. The method of claim 1 wherein the matrix is synthesized from a substance selected from the group consisting of a nitrogen containing polymer, a nitrogen containing monomer, and a combination thereof.

8. The method of claim 1 wherein the matrix is synthesized from a diamine, 2,6-bis(3-aminophenoxy)benzonitrile (β-CN)APB), and a dianhydride, pyromellitic dianhydride (PMDA).

9. The method of claim 1 wherein the concentration of boron nitride in the matrix is between 0% and 5% by weight.

10. The method of claim 1 wherein the concentration of boron nitride in the matrix is 5% by weight.

11. The method of claim 1 wherein the boron containing nanomaterial comprises boron, nitrogen, carbon and hydrogen.

12. The method of claim 1 wherein the synthesized material is in a form selected from the group consisting of a film, a fiber, a paste and a foam.

13. The method of claim 12 wherein the synthesized fiber is incorporated into fabric.

14. The method of claim 12 wherein the synthesized paste is applied to the surface of an object to provide protection from radiation.

15. The method of claim 12 wherein the synthesized paste forms a layer within an object to provide protection from radiation.

16. The method of claim 1 wherein the matrix is a polymer matrix.

17. The method of claim 1 wherein the matrix is a ceramic matrix.
